(19) United States
(12) Patent Application Publication
(10) Pub. No.: US 2002/0168586 A1
(43) Pub. Date: Nov. 14, 2002

(54) Near field optical disk

(76) Inventors: Shih-Che Lo, I-Lan Hsien (TW); Hsi-Hsiang Lin, I-Lan Hsien (TW); Horng-Nian Wang, Taipei (TW)

Correspondence Address: BACON & THOMAS, PLLC, 4th Floor, 625 Slaters Lane, Alexandria, VA, 22314-1176, US

(21) Appl. No.: 09/852,080

(22) Filed: May 10, 2001

(51) Int. Cl. G11B 7/24; G11B 7/26

(52) U.S. Cl. 430/270.12; 430/945; 428/64.8; 369/283

(57) ABSTRACT

This invention is to provide a kind of near-field optical disk. This near-field optical disk is formed by a recording layer, a suitable thickness of near-field layer, a silver halide compound of light scattering layer, and a protection layer on the substrate layer in sequence. It is not necessary to increase the energy of transmitting beam for that the recording layer of this near-field optical disk and the transmitting beam has accomplished recording at a near-field distance to obtain the higher recording density.

### BACKGROUND OF THE INVENTION

This invention is to provide a kind of near-field optical disk in which the recording layer of this near-field optical disk and the transmitting beam has accomplished recording at a near-field distance to obtain the higher recording density through a suitable thickness of near-field layer and a silver halide compound of light scattering layer.

Limitations of many of commercial storages are too small capacity, easily out of order, not portable, and poor circulation. But, the optical disk can solve all limitations described above, especially, the recording software and the low-cost optical disk recorder are very available in the market to enhance the recordable optical disk be in the fashion.

The capacity of most optical disk is over 640 Mb, but the digital audio-video data and the complete function software need a large storage space in order to contain more data in a piece of optical disk.

The data storage capacity of optical disk is dependent on the amount of recording density. To increase the capacity of optical disk has to increase its recording density. It is too hard to increase the recording density under the principle of a far-field due to the limitation of light scattering; hence, it needs to proceed recording using the principle of a near-field to obtain the higher recording density.

FIG. 1 shows a cross-sectional view of a known general optical disk structure. This known general optical disk 11 is formed by a containing merocyanine dye compound recording layer 3, a selective AuAgAl or CuCr alloy reflex layer 4, and a lacquer protection layer 5 on a polycarbonate substrate layer 2 in sequence. When it is recording, the transmitting beam is transmitting through the reflex layer 4 to the recording layer 3 in order that the heat energy of the transmitting beam causes merocyanine dye compound in the recording layer 3 being changed to proceed recording.

FIG. 2 shows a cross-sectional view of the structure a known near-field optical disk 12. A known near-field optical disk is formed by a recording layer 3, a containing ZnS—SiO₂ near-field layer 6, a containing AgOₓ the first light scattering layer 71, and a containing ZnS—SiO₂ protection layer 8 on a polymer substrate layer 2 in sequence.

FIG. 3 shows a light scattering layer reaction for a known near-field optical disk. Using light beam to heat up to break the oxygen and silver bond in containing AgOₓ the first light scattering layer 71 to form a silver atom; once the heat energy is diminished, oxygen and silver atoms are bonded back together to produce a thermo-activating light switch. The recording layer of this near-field optical disk and the transmitting beam accomplish recording at a near-field distance to obtain the higher recording density. In a known technique of a near-field optical disk it employs the heating method to break the bond between oxygen and silver in AgOₓ, however, since the bond energy of Ag—O in AgOₓ is very high, it needs to use the more powerful light beam to produce the higher energy and it causes the higher temperature.

In a known technique described above, both of the light scattering layer and the recording layer of a near-field optical disk employ the heating method, after the transmitting beam reacts with silver oxide of the light scattering layer, part of energy has been absorbed by silver oxide, hence, it easily causes the failure of recording since the heat energy is not enough while it delivers to the recording layer.

### SUMMARY OF THE INVENTION

Hence, the aim of this invention is to solve the drawbacks described above. In order to avoid the presence of the drawbacks described above, this invention is to provide a kind of near-field optical disk in which it is not necessary to use the more powerful light beam while the optical disk is proceeding recording, hence, it can reduce the consumption of energy.

The other aim of this invention is to provide a kind of near-field optical disk in which the light scattering layer is not necessary to use the heating method to bind a silver atom and halogen atom back together.

The other aim of this invention is to provide a kind of near-field optical disk in which the light scattering layer employs the light reaction so that the speed of reading- writing is much faster.

The other aim of this invention is to provide a kind of near-field optical disk in which the reaction between the light scattering layer and the recording layer does not interfere with each other.

In order to get the aims described above, this invention is to provide a kind of near-field optical disk in which it is formed by a recording layer, a suitable thickness of near-field layer, a silver halide compound of light scattering layer, and a protection layer on the substrate layer in sequence, so that the recording layer of this near-field optical disk and the transmitting beam has accomplished recording at a near-field distance to obtain the higher recording density.

### BRIEF DESCRIPTION OF THE DRAWINGS

FIG. 1 illustrates the cross-sectional view of a known general optical disk structure.

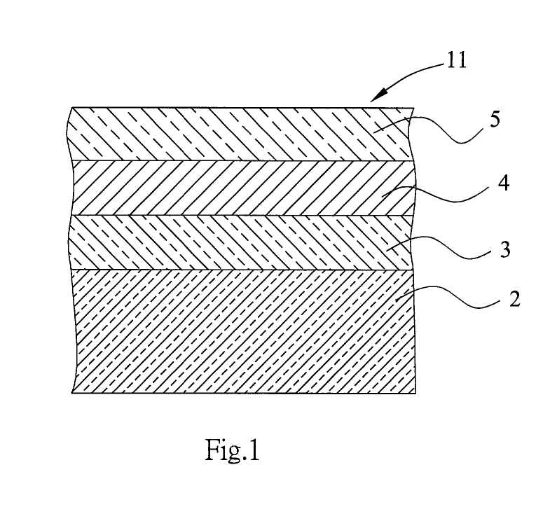

FIG. 2 illustrates the cross-sectional view of a known near-field optical disk structure.

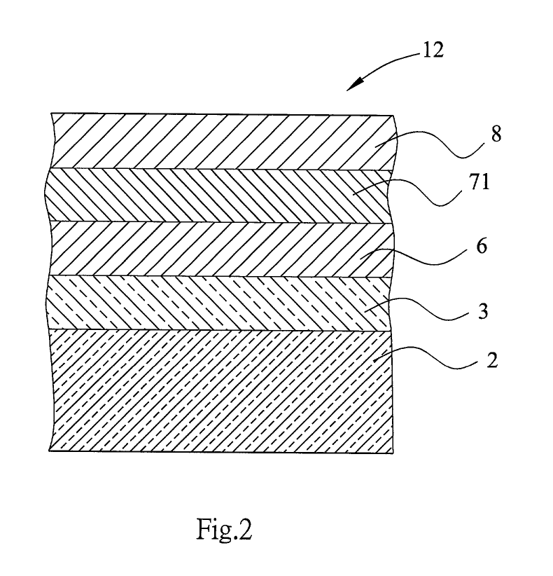

FIG. 3 illustrates an equation for the light scattering layer of near-field optical disk.

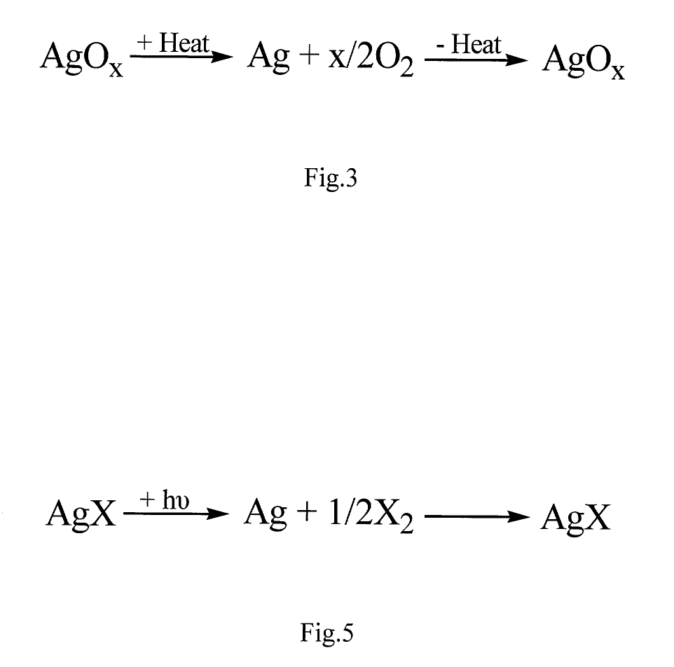

FIG. 4A, FIG. 4B, FIG. 4C, FIG. 4D, and FIG. 4E illustrate the cross-sectional view for the every process of a near-field optical disk structure of this invention.

FIG. 5 illustrates an equation of the light scattering layer of a near-field optical disk structure of this invention.

FIG. 6 illustrates the double-beam of the transmitting beam.

FIG. 7 illustrates the single-beam of the transmitting beam.

### DETAILED DESCRIPTION OF THE PREFERRED EMBODIMENTS

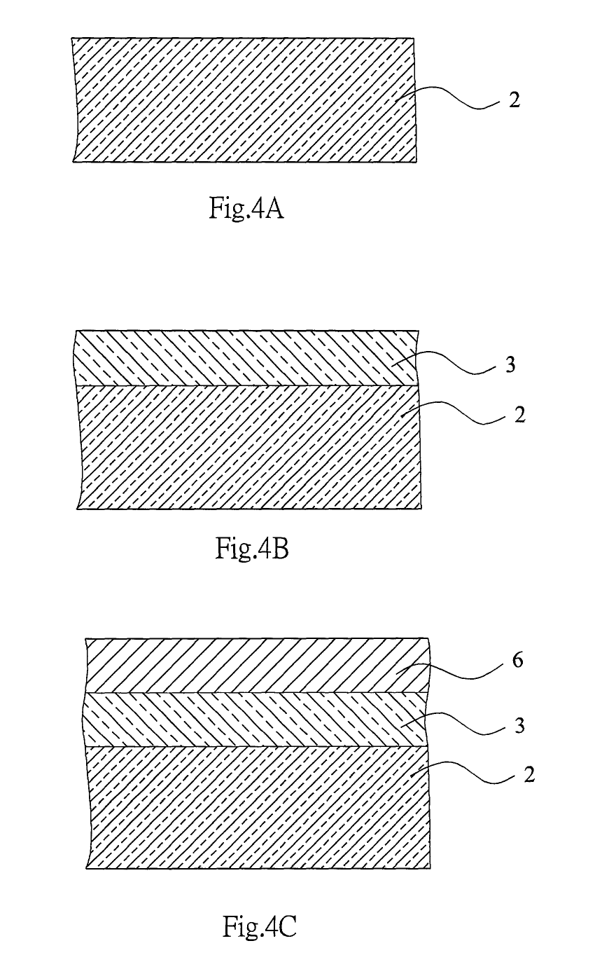

FIGS. 4A-E show the cross-sectional views for the every process of the near-field optical disk of this invention, the near-field optical disk 12 of this invention is to form the recording layer 3 on the glass or polycarbonate substrate layer 2 by using spin coating or sputtering method, and the recording layer 3 is GeSbTe alloy or merocyanine dye compound, the thickness is in the range of 1˜500 nm; to form the near-field layer 6 on the recording layer by using sputtering or chemical vapor deposition (CVD) method, and the near-field layer 6 is Si₃N₄ or ZnS—SiO₂, the thickness is in the range of 1˜500 nm; to form the second light scattering layer 72 on the near-field layer 6 by using evaporation or sputtering method, the second light scattering layer 72 is silver fluoride AgF, silver chloride AgCl, silver bromide AgBr, or silver iodide AgI etc. one of silver halide AgX compound, the thickness is in the range of 1˜500 nm; to form the protection layer 8 on the second light scattering layer 72 by using sputtering or chemical vapor deposition method, the protection layer 8 is Si₃N₄ or ZnS—SiO₂, the thickness is in the range of 1˜500 nm.

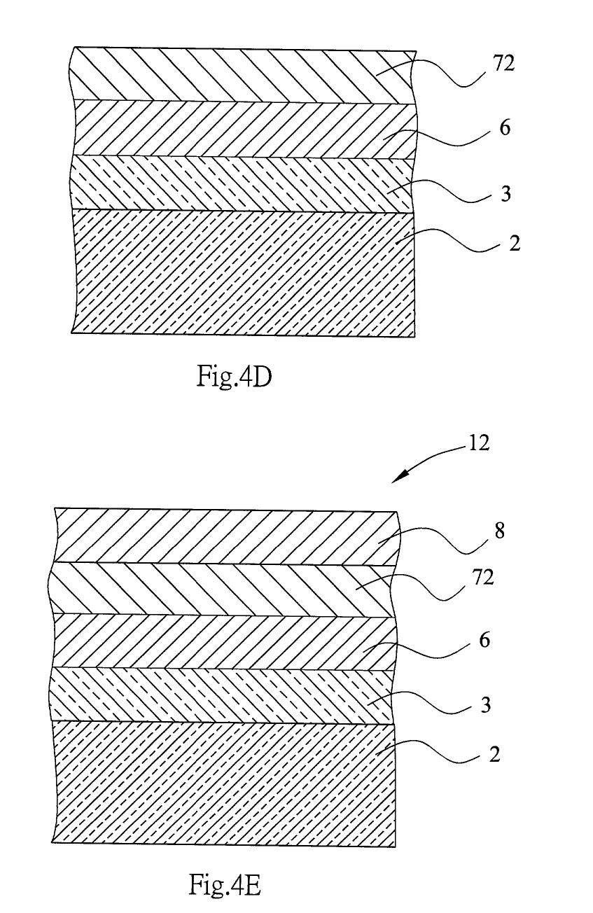

FIG. 5 shows an equation of the light scattering layer of a near-field optical disk structure of this invention, it utilizes the specific wavelength light beam to break the bond between oxygen and silver to produce silver atom in the containing silver oxide AgOₓ the second light scattering layer 72 of the near-field optical disk of this invention, after ceasing beam irradiating the silver atom and the halogen atom can be bonded back together to form a light-activating light switch. The recording layer of this near-field optical disk and the transmitting beam has accomplished recording at a near-field distance to obtain the higher recording density.

Containing silver halide AgX light scattering layer of the near-field optical disk of this invention is silver fluoride AgF, silver chloride AgCl, silver bromide AgBr, or silver iodide AgI according to the different kind of halogen atom, four kinds of silver halides possess the similar physical and chemical properties, but the use of touching off light beam activating light switch is still different according to the different kind of silver halide AgX in the light scattering layer.

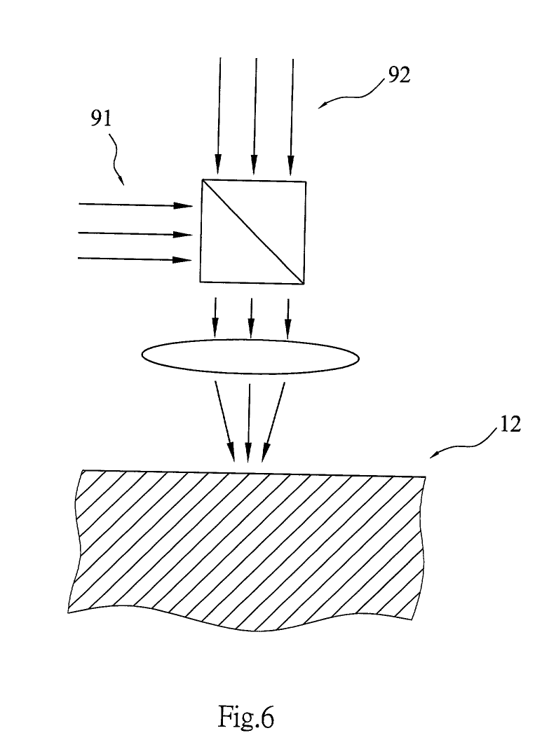

The light scattering layer of this invention is to use the wavelength of the transmitting beam for the reaction, hence, the light beams employed in the touching off light scattering layer and in the proceeding recording are not the same as shown in FIG. 6, the figure of a double-beam of the transmitting beam, It needs to employ two kinds of beams, one is the wavelength should be enough to be the touching off light beam 91 to reduce silver halide to silver atom in the light scattering layer, the other is to be the reading-writing light beam 92 while the energy is enough to heat up the recording layer in order that the merocyanine dye compound causes the chemical reaction change in the recording layer.

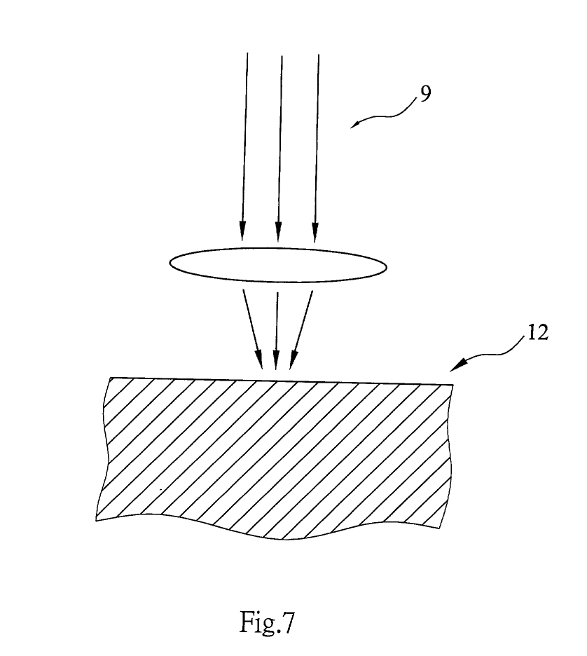

If the reaction method of the recording layer material is changed from the heating mechanism to the light reaction mechanism, and is the same as the wavelength of the light beam being employed in the touching off light scattering layer as shown in FIG. 7, the figure of a single-beam of the transmitting beam, it needs to employ a kind of transmitting beam 9 to accomplish.

This invention specially discloses and describes selected the best examples. It is to be understood, however, that this invention is not limited to the specific features shown and described. The invention is claimed in any forms or modifications within the spirit and the scope of the appended claims.

What is claimed is:

1. A kind of near-field optical disk in which the light scattering layer contains the structure (I) of silver halide compound:
Ag—X (I)
X is halogen atom.

2. A near-field optical disk of claim 1, wherein said silver halide compoumd is chosen from the group of silver fluoride AgF, silver chloride AgCl, silver bromide AgBr, and silver iodide AgI.

3. A near-field optical disk of claim 1, wherein said the light scattering layer is formed by using sputtering method.

4. A near-field optical disk of claim 1, wherein said the thickness of the light scattering layer is in the range of 1˜500 nm.
